(19) United States
(12) Patent Application Publication
(10) Pub. No.: US 2025/0260513 A1
(43) Pub. Date: Aug. 14, 2025

(54) METHOD FOR GENERATING BROADCAST TRANSMISSION SIGNAL BASED ON SIGNALING ENCODING USING POLAR CODE AND APPARATUS FOR THE SAME

(71) Applicant: ELECTRONICS AND TELECOMMUNICATIONS RESEARCH INSTITUTE, Daejeon (KR)

(72) Inventors: Seok-Ki AHN, Daejeon (KR); Sung-Ik PARK, Daejeon (KR); Sun-Hyoung KWON, Daejeon (KR)

(73) Assignee: ELECTRONICS AND TELECOMMUNICATIONS RESEARCH INSTITUTE, Daejeon (KR)

(21) Appl. No.: 19/052,381

(22) Filed: Feb. 13, 2025

(30) Foreign Application Priority Data
Feb. 14, 2024 (KR) 10-2024-0020844
Feb. 14, 2024 (KR) 10-2024-0020861
Feb. 4, 2025 (KR) 10-2025-0013976
Feb. 12, 2025 (KR) 10-2025-0017705

(51) Int. Cl. H04L 1/00

(52) U.S. Cl. CPC H04L 1/0068; H04L 1/0041; H04L 1/0057

(57) ABSTRACT

Disclosed herein are a method for generating a broadcast transmission signal based on signaling encoding using a polar code and an apparatus for the method. The apparatus for generating a broadcast transmission signal includes a polar encoder configured to generate a polar codeword by encoding an input bit sequence based on a polar code, a rate matcher configured to select a rate matching method in consideration of a mother matrix size (N) of the polar code and a length of a transmission bit sequence (E), and generate the transmission bit sequence from the polar codeword using the selected rate matching method, and an additional parity generator configured to generate additional parity bits in consideration of the rate matching method.

### CROSS REFERENCE TO RELATED APPLICATIONS

This application claims the benefit of Korean Patent Application Nos. 10-2024-0020861, filed Feb. 14, 2024, 10-2024-0020844, filed Feb. 14, 2024, 10-2025-0013976, filed Feb. 4, 2025, and 10-2025-0017705, filed Feb. 12, 2025, which are hereby incorporated by reference in their entireties into this application.

### BACKGROUND OF THE INVENTION

### 1. Technical Field

The present disclosure relates to technology for encoding and transmitting signaling information using polar codes, and more particularly to technology for determining whether signaling information bits are to be segmented and the number of segments and performing rate matching, based on an encoding process using a polar code, a process of generating a transmission signal using the codeword of the polar code, a process of generating additional parity using the codeword of the polar code, and parameters related to encoding.

### 2. Description of the Related Art

In information society of the 21st century, broadcasting and telecommunication services are entering an era of full digitalization, multi-channel expansion, broadband connectivity, and high-quality implementation. In particular, with the recent widespread adoption of high-definition digital TVs and mobile broadcasting devices, there is a growing demand for digital broadcasting services to support various reception methods.

In response to these demands, standardization groups have established various standards to provide various types of services capable of meeting user needs. Consequently, there is a need to explore measures to provide better services to users through enhanced performance.

### PRIOR ART DOCUMENTS

### Patent Documents

(Patent Document 1) Korean Patent Application Publication No. 10-2016-0106477 (Date of Publication: Sep. 12, 2016, Title: Transmitter and Segmentation Method thereof)

### SUMMARY OF THE INVENTION

Accordingly, the present invention has been made keeping in mind the above problems occurring in the prior art, and an object of the present invention is to more efficiently encode information based on a polar code when control information and signaling information required for data reception are transmitted and received in a communication and broadcasting system that transmits data to multiple users.

Another object of the present disclosure is to generate and transmit additional parity to enhance the reception performance of signaling encoded using a polar code.

A further object of the present disclosure is to encode information using error-correcting codes in the cases where errors and data loss occur or may occur due to noise, interference, or other factors during the transmission or storage of data.

Yet another object of the present disclosure is to propose a criterion and a method for segmenting signaling to perform stable and efficient encoding and decoding using a polar code, and propose a method for generating a bit sequence to be used for transmission signal generation using a polar codeword.

In accordance with an aspect of the present disclosure to accomplish the above objects, there is provided an apparatus for generating a broadcast transmission signal, including a polar encoder configured to generate a polar codeword by encoding an input bit sequence based on a polar code; a rate matcher configured to select a rate matching method in consideration of a mother matrix size (N) of the polar code and a length of a transmission bit sequence (E), and generate the transmission bit sequence from the polar codeword using the selected rate matching method; and an additional parity generator configured to generate additional parity bits in consideration of the rate matching method.

The rate matching method may be selected as any one of puncturing, shortening, and repetition.

The rate matching method may be selected as any one of the puncturing or the shortening when the length of the transmission bit sequence (E) is less than the mother matrix size (N), and is selected as the repetition when the length of the transmission bit sequence (E) is greater than the mother matrix size (N).

The shortening may perform rate matching by extracting bits while leaving (N−E) bits from an end of a virtual circular buffer in which the polar codeword is stored, the puncturing may perform rate matching by skipping (N−E) bits from a start of the virtual circular buffer in which the polar codeword is stored, and then extracting bits from a next position, and the repetition performs rate matching by extracting all of N bits stored in the virtual circular buffer in which the polar codeword is stored, and then repeatedly extracting remaining (E−N) bits from the start of the virtual circular buffer.

The polar codeword may be subjected to interleaving, and then stored in the virtual circular buffer.

The additional parity generator may be configured to, when the shortening is used as the rate matching method, generate the additional parity bits by storing remaining bits, excluding shortened bits from bits stored in the virtual circular buffer, in an additional virtual circular buffer, and thereafter sequentially extracting bits from the additional virtual circular buffer.

The additional parity generator may be configured to, when the puncturing is used as the rate matching method, generate the additional parity bits by sequentially extracting bits starting from a punctured bit among bits stored in the virtual circular buffer.

The additional parity generator may be configured to, when the repetition is used as the rate matching method, generate the additional parity bits by sequentially extracting bits following a last bit extracted through the repetition from the virtual circular buffer.

The mother matrix size (N) may be determined to correspond to N=2^{┌log}^{₂}^{E┐} or N=2^{┌log}^{₂}^{E┐-1} for the length of the transmission bit sequence (E).

The polar encoder may determine a number of frozen bits in consideration of a number of signaling bit sequences (K) in L1-basic signaling subjected to outer encoding or in segmented L1-detail signaling.

Here, the number of frozen bits may correspond to a value N−(K+C) obtained by subtracting the sum of the number of signaling bit sequences K and the parity length C of an outer code, on which outer encoding is performed, from the input bit length N of the polar encoding graph corresponding to the mother matrix size N.

Here, the frozen bits may be located at the front or rear of the predefined polar code sequence among the input bits of the polar encoding graph.

In accordance with another aspect of the present disclosure to accomplish the above objects, there is provided a method for generating a broadcast transmission signal based on signaling encoding using a polar code according to an embodiment of the present disclosure is performed by a broadcast signal generation apparatus, and includes generating a polar codeword by encoding an input bit sequence based on a polar code; selecting a rate matching method in consideration of a mother matrix size (N) of the polar code and a length of a transmission bit sequence (E); generating the transmission bit sequence from the polar codeword using the selected rate matching method; and generating additional parity bits in consideration of the rate matching method.

Here, the rate matching method may be selected as any one of puncturing, shortening, and repetition.

Here, the rate matching method may be selected as any one of the puncturing or shortening method when the length of the transmission bit sequence E is less than the mother matrix size N, and may be selected as the repetition method when the length E of the transmission bit sequence is greater than the mother matrix size N.

The shortening may perform rate matching by extracting bits while leaving (N−E) bits from an end of a virtual circular buffer in which the polar codeword is stored, the puncturing may perform rate matching by skipping (N−E) bits from a start of the virtual circular buffer in which the polar codeword is stored, and then extracting bits from a next position, and the repetition may perform rate matching by extracting all of N bits stored in the virtual circular buffer in which the polar codeword is stored, and then repeatedly extracting the remaining (E−N) bits from the start of the virtual circular buffer.

The polar codeword may be stored in the virtual circular buffer after performing interleaving on the polar codeword.

When shortening is used as the rate matching method, generating the additional parity bit may include storing the remaining bits, excluding the shortened bits from the bits stored in the virtual circular buffer, in an additional virtual circular buffer, and then sequentially extracting bits from the additional virtual circular buffer.

Generating the additional parity bit may include, when puncturing is used as the rate matching method, generating the additional parity bit by sequentially extracting bits starting from a punctured bit among the bits stored in the virtual circular buffer.

Generating the additional parity bit may include, when repetition is used as the rate matching method, generating the additional parity bits by sequentially extracting bits following a last bit extracted through the repetition from the virtual circular buffer.

The mother matrix size (N) may be determined to correspond to N=2^{┌log}^{₂}^{E┐} or N=2^{┌log}^{₂}^{E┐-1} for the length of the transmission bit sequence (E).

Generating the polar codeword may include determining the number of frozen bits in consideration of the number of signaling bit sequences (K) in L1-basic signaling subjected to outer encoding, or segmented L1-detail signaling.

The number of frozen bits may correspond to a value N−(K+C) obtained by subtracting a sum of the number of signaling bit sequences (K) and a parity length (C) of an outer code, on which outer encoding is performed, from an input bit length (N) of a polar encoding graph corresponding to the mother matrix size (N).

The frozen bits may be located at a front or rear of a predefined polar code sequence among input bits of the polar encoding graph.

In accordance with a further aspect of the present disclosure to accomplish the above objects, there is provided a method for generating a broadcast transmission signal, the method being performed by an apparatus for generating a broadcast transmission signal, the method including determining whether segmentation is to be performed on L1-detail signaling by applying at least one of multiple conditions that are set based on a mother matrix size of a polar code (N), a number of bits (K) in the L1-detail signaling, and a length of a transmission bit sequence (E), or a combination thereof; when the segmentation is to be performed, determining a number of segments based on parameters that are set in consideration of N; and performing segmentation in accordance with the determined number of segments, and determining a length of a bit sequence subjected to rate matching in consideration of a target block error rate and a number of bits in segmented L1-detail signaling.

The multiple conditions may include a first condition in which the segmentation is performed when K≥(N−C) is satisfied based on a number of parity bits (C) in a CRC code, a second condition in which the segmentation is performed when E≥B is satisfied based on a first parameter (B) that is set in consideration of N, and a third condition in which the segmentation is performed when E≥B is satisfied while K≥A is satisfied based on a second parameter (A) that is set in consideration of N.

The number of segments (c) may be determined to be c=┌K/(N−C−1)┐ when the segmentation is performed by satisfying the first condition, to be c=┌E/(B−1)┐ when the segmentation is performed by satisfying the second condition, and to be c=min (┌K/(A−1)┐, ┌E/(B−1)┐) when the segmentation is performed by satisfying the third condition.

Determining the length of the bit sequence subjected to the rate matching may include, in consideration of a situation in which, as (e) that is the length of the bit sequence subjected to the rate matching increases, the block error rate decreases, determining the length of the bit sequence (e) for the number of bits (k) in the segmented L1-detail signaling based on the target block error rate.

The length of the bit sequence (e) may be a value in which a number of bits (p) punctured or shortened in rate matching and a number of bits (r) added through repetition in rate matching are applied to the k.

The method may further include, when the (e) is determined, determining the rate matching method by comparing, by the broadcast transmission signal generation apparatus, the mother matrix size of the polar code (N) with the length of the bit sequence (e) subjected to the rate matching.

Determining the rate matching method may include using repetition when e>N is satisfied, and using puncturing or shortening when e<N is satisfied.

In accordance with yet another aspect of the present disclosure to accomplish the above objects, there is provided an apparatus for generating a broadcast transmission signal may include a segmenter configured to determine whether segmentation is to be performed on L1-detail signaling by applying at least one of multiple conditions that are set based on a mother matrix size (N) of a polar code, a number of bits (K) in L1-detail signaling, and a length (E) of a transmission bit sequence, or a combination thereof and configured to, when it is determined that the segmentation is to be performed, determine a number of segments based on parameters that are set in consideration of the mother matrix size (N) of the polar code, and perform segmentation in accordance with the determined number of segments; and a rate matcher configured to determine a length of a bit sequence subjected to rate matching in consideration of a target block error rate and the number of bits in the segmented L1-detail signaling.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating the configuration of a physical layer frame;

FIG. 2 is a diagram illustrating an example of a process of encoding a polar code;

FIG. 3 is an operation flowchart illustrating a method for generating a broadcast transmission signal based on signaling encoding using a polar code according to an embodiment of the present disclosure;

FIG. 4 is a diagram illustrating an example of a process for receiving L1-basic signaling and generating a transmission signal according to an embodiment of the present disclosure;

FIG. 5 is a diagram illustrating an example of a process for receiving L1-detail signaling and generating a transmission signal according to an embodiment of the present disclosure;

FIG. 6 is an operation flowchart illustrating in detail a polar encoding process according to an embodiment of the present disclosure;

FIGS. 7 and 8 are diagrams illustrating an apparatus for generating a broadcast transmission signal based on signaling encoding using a polar code according to an embodiment of the present disclosure; and

FIG. 9 is an operation flowchart illustrating a method for generating a broadcast transmission signal using signaling segmentation based on polar encoding according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, embodiments of the present disclosure will be described in detail with reference to the attached drawings.

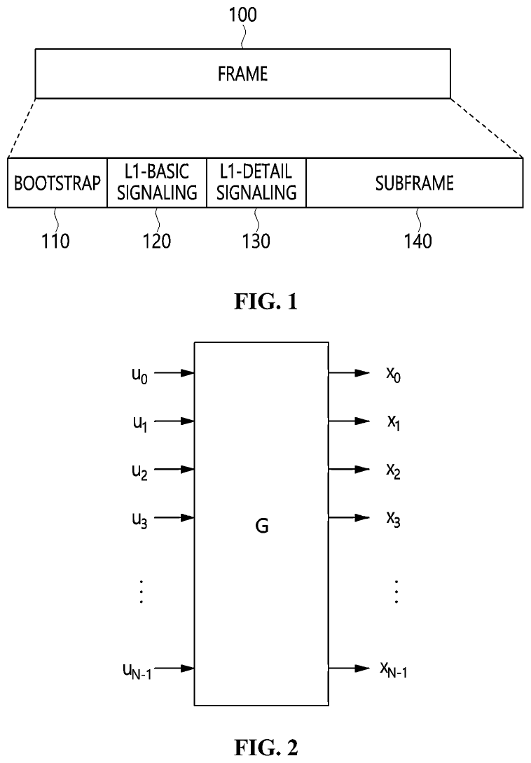

FIG. 1 is a diagram illustrating the configuration of a physical layer frame.

Referring to FIG. 1, the physical layer of a communication and broadcasting system may be composed of initial synchronization, control signaling transmission, and data transmission.

For example, referring to FIG. 1, the physical layer of an Advanced Television Systems Committee (ATSC) 3.0 system is transmitted in frame units, and a frame 100 may be composed of three parts, that is, a bootstrap 110, a preamble 120/130, and a subframe 140 in which data is transmitted.

The bootstrap 110 may be used for initial synchronization, may additionally transmit parameter information required for receiving L1 signaling, and may include information about a mode in which L1-basic signaling is processed.

Here, L1 signaling is transmitted with it included in the preamble, and may be composed of two parts, that is, L1-basic signaling 120 and L1-detail signaling 130. Here, the L1-basic signaling 120 may include information about L1-detail signaling 130, and the L1-detail signaling 130 may include information required for receiving data. Here, data may be data required to provide a broadcasting service, and may be transmitted in the form of one or more physical layer pipes (PLPs).

The L1-basic signaling 120 may include pieces of information required by a receiver to process the L1-detail signaling 130. For example, the L1-basic signaling 120 may include information about the length of the L1-detail signaling 130, a mode in which the L1-detail signaling 130 is processed by a transmitter, whether additional parity is to be transmitted, an additional parity mode, etc. The L1-basic signaling 120 may further include significant physical layer parameters such as a Fast Fourier Transform (FFT) size used for the transmission of the subframe 140, a guard interval, and a pilot pattern.

On the other hand, the L1-detail signaling 130 may transmit pieces of information required by the receiver to receive one or more PLPs. For example, the L1-detail signaling 130 may include the starting positions of cells to which data symbols are mapped for respective PLPs, the sizes of PLPs, PLP IDs, a modulation method used in the subframe 140, the code rate of a Low-Density Parity-Check (LDPC) code, and the like.

Consequently, the receiver may obtain frame synchronization through the signal of the bootstrap 110, process the L1-detail signaling 130 based on the information obtained from the L1-basic signaling 120, and receive data needed by a user from the subframe 140 based on information in L1-detail signaling 130.

Here, the L1-basic signaling 120 and the L1-detail signaling 130 may be protected through the concatenation of an outer code and an inner code.

For example, a Bose-Chaudhuri-Hocquenghem (BCH) code or a Cyclic Redundancy Check (CRC) code may be used as the outer code. A channel code such as an LDPC code or a polar code may be used as the inner code. Further, L1 signaling may be protected only through an inner code without requiring an outer code. Furthermore, in order to provide various robustness levels for adapting to Signal-to-Noise Ratio (SNR) covering a wide range in which an actual transmission environment is taken into consideration, the protection level of the L1-basic signaling 120 and of the L1-detail signaling 130 may be classified into seven modes. Encoding-related parameters, modulation order, and the like of channel codes used depending on the mode may vary, and different protection levels may be provided when L1 signaling is transmitted through the encoding-related parameters or modulation order.

Here, the mode to be used by the transmitter to process signaling may be preset. For example, the transmitter may determine parameters for generating a signaling-related transmission signal depending on the preset mode, generate a transmission signal based on the determined parameters, and transmit the transmission signal to the receiver.

For this, the transmitter may pre-store parameters that are used for respective modes. For example, the number of bits in the L1-basic signaling 120 may always be fixed at 200. On the other hand, the number of bits in the L1-detail signaling 130 is variable. Therefore, when the number of bits in L1-detail signaling 130 is greater than a preset value, the L1-detail signaling may be divided into multiple segments, each having a length less than or equal to a preset value, through segmentation before being subjected to channel encoding.

Meanwhile, the polar code proposed by Arikan has been theoretically proven to achieve channel capacity. When information word bits are encoded using a polar code, the polar code is mainly used in the form of a code concatenated with a CRC code. A polar code using a successive cancellation (SC) decoding method has been theoretically proven to achieve point-to-point channel capacity in the case of a codeword having an infinite length by utilizing channel polarization. Furthermore, it has been verified that, even when a polar code is used in a communication and broadcasting system in which a codeword length is finite, it is used in the form of a concatenated code in which a CRC code is used as an outer code, and thus superior performance is exhibited when a codeword length is shorter compared to other channel codes in case that Successive Cancellation List (SC-list: SCL) decoding is used. For this reason, 3GPP 5G New Radio (NR) adopts the polar code as a channel code for control channels.

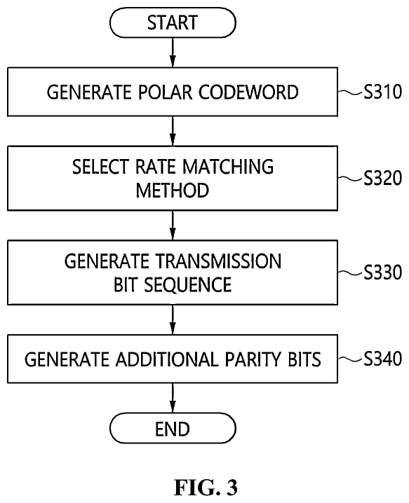

FIG. 2 is a diagram illustrating an example of a process of encoding a polar code.

Referring to FIG. 2, an information bit sequence desired to be transmitted may be segmented into multiple segments depending on the size of an encoding graph of a polar code. Thereafter, respective segmented information bit sequences may be input to a polar encoder.

Hereinafter, a concatenated encoding process using a polar code will be described on the assumption that an i-th information bit sequence that is an i-th segment is input.

First, the input bit sequence may be outer-encoded through an outer encoder, and such outer encoding may facilitate error detection in a reception stage or may enhance reception performance. Here, the outer code can be used to enhance the performance of a maximum likelihood (ML)-decoder, such as that represented by SCL decoding. For example, a CRC code or a BCH code may be used as the outer code for the polar code. As the outer code, only a single outer code may be used, or two or more outer codes may be sequentially used. Alternatively, outer codes may be omitted.

A bit sequence of length L, which has been subjected to outer encoding in this way, may be mapped to an input bit sequence for polar encoding. Here, the length of the input bit sequence that is input to the polar encoder may be N, where N has a value greater than L.

For example, N may be the size of the encoding graph of a polar code, and may be represented by a power of 2. Referring to FIG. 2, u may be the input bit sequence of the polar encoder, and a bit sequence b, which is subjected to outer encoding depending on a preset method, may be mapped to u. Here, an operation of mapping the bit sequence b into the bit sequence u may be determined based on the bit index of u, which is predefined in the form of a sequence. Even in the case of a polar code used in the control channel of 3GPP NR, the bit index of u is predefined in the form of a sequence and used to map the information word bit sequence b to the input sequence u of the polar encoder. Furthermore, such a mapping operation may be performed in consideration of a code rate matching (i.e., rate matching) operation applied after the polar encoding operation.

When sequence mapping is analyzed based on the channel polarization of the polar code, it may be considered that individual bits of the input sequence u of the encoder are allocated to sub-channels having different qualities after channel polarization. Therefore, mapping b to u may be regarded as allocating b corresponding to information word bits to sub-channels of the polar encoder based on the polar encoder.

For example, among the sub-channels of u, sub-channels to which b is mapped may be referred to as unfrozen bits, and the remaining sub-channels may be referred to as frozen bits. Consequently, it may be considered that the polar encoding process transmits information words through good sub-channels generated after channel polarization, and prevents information words from being transmitted through the bad sub-channels by allocating frozen bits to the bad sub-channels.

In this case, the frozen bits may be fixed at the preset values, and may be fixed at ‘0’ in 3GPP NR. In this case, for an arbitrary length N, priorities to be used for information bit transmission between sub-channels may be predetermined based on the quality of the sub-channels, and may be defined in the form of a sequence, which may be referred to as a polar code sequence.

Furthermore, during a rate matching operation, frozen bits may be forcibly allocated to some channels due to puncturing or shortening, and the order of allocation of frozen bits in this way may be obtained from a polar code sequence.

That is, the polar encoder may receive an input sequence u including frozen bits and perform encoding on the input sequence u, thus generating a bit sequence having the same length as the input sequence u.

In detail, as illustrated in FIG. 2, the polar encoder may receive an input bit sequence u of length N, and may generate an encoding output sequence x=uG_{N} of length N by multiplying a polar code generator matrix G_{N} having a size of N×N by the input bit sequence u. Here, the encoding output sequence x may be called a polar codeword.

Generally, the polar code generator matrix G_{N} may be defined by the following Equation (1):

$${G}_{N} = {B}_{N} {F}^{\times {log}_{2} N} \qquad ( 1 )$$

Here, N may be the size (length) of the mother matrix of the polar code that is a square matrix, G_{N} may be the generator matrix, and matrix

$$F = [ \begin{matrix}1 & 0 \\ 1 & 1\end{matrix} ] \times n$$

may indicate that a Kronecker power operation is performed n times. For example,

$${F}^{\times 2} = [ \begin{matrix}F & 0 \\ F & F\end{matrix} ] .$$

Further, B_{N} represents a bit-reversal permutation matrix having a size of N×N. For example, the operation of B₄ of length 4 may calculate a bit vector (b₀, b₂, b₁, b₃) having a reversed bit order by multiplying B₄ by a bit vector such as (b₀, b₁, b₂, b₃).

Here, in the polar encoding operation, the B_{N} operation may be skipped, and in this case, the generator matrix may be defined by the following Equation (2):

$${G}_{N} = {F}^{\times {log}_{2} N} \qquad ( 2 )$$

In the present disclosure described below, it is assumed that the B_{N} operation is skipped in the generator matrix, and content related thereto may be easily converted into a polar code that uses the generator matrix defined to include the B_{N} operation based on the bit-reversal permutation operation.

The present disclosure relates to a method for encoding and transmitting control information or signaling information required by a terminal to receive data using a polar code in a communication and broadcasting system that transmits data to multiple users.

Hereinafter, although embodiments of the present disclosure will be described based on the ATSC 3.0 system as an example for convenience of description, the embodiments of the present disclosure may also be applied to any communication and broadcasting systems. That is, for convenience of description, a transmission signal will be described as an ATSC 3.0 signal, and may be a broadcast signal in other broadcast transmission technologies such as DVB or ISDB-T if necessary.

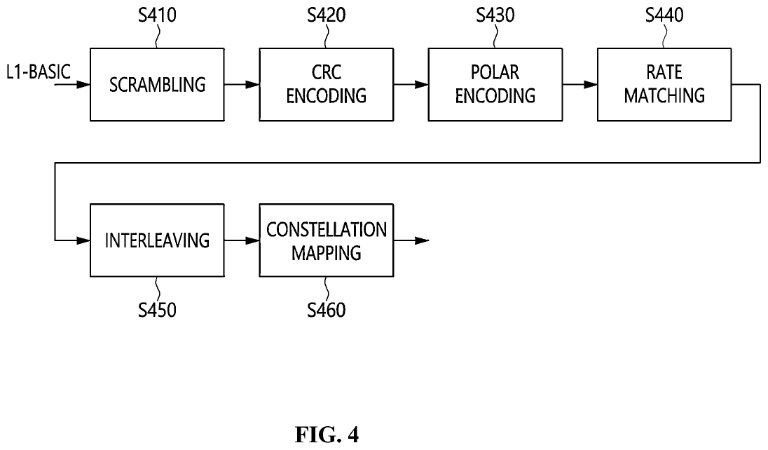

FIG. 3 is an operation flowchart illustrating a method for generating a broadcast transmission signal based on signaling encoding using a polar code according to an embodiment of the present disclosure.

Here, the physical layer signals of ATSC 3.0 are transmitted in frames, and each frame is composed of a bootstrap, a preamble, and a subframe. In order to receive data that is transmitted through the subframe, L1-basic signaling and L1-detail signaling which are transmitted through the preamble need to be successfully decoded in a reception stage. For this operation, the present disclosure may generate a broadcast transmission signal by effectively encoding L1-basic signaling and L1-detail signaling using a polar code.

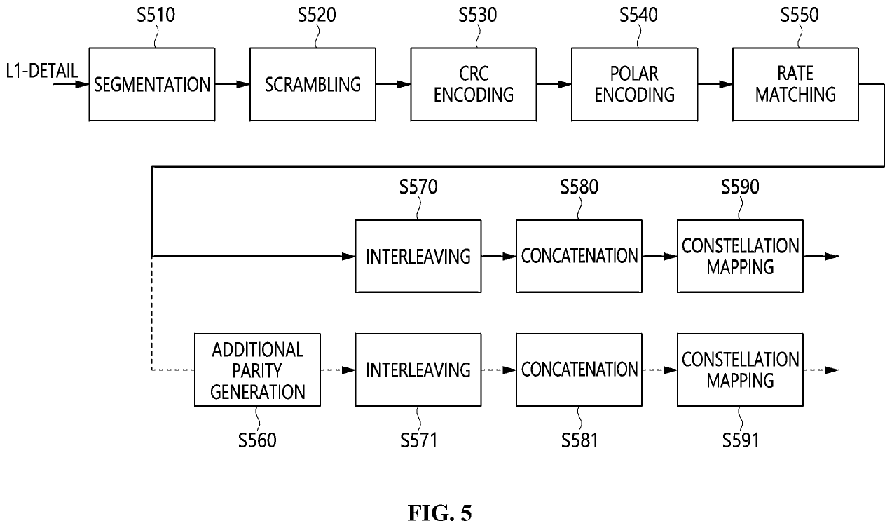

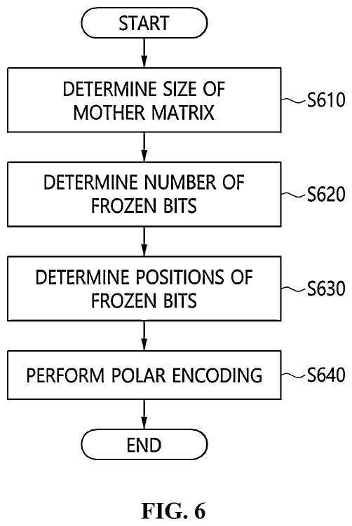

Here, during a process of generating the broadcast transmission signal, the remaining procedure, other than inner encoding, rate matching, and additional parity generation that use a polar code, will be described in detail later with reference to FIGS. 4 and 5. In the process of generating the broadcast transmission signal, details of procedures for inner encoding, rate matching, and additional parity generation that use the polar code will be described with reference to FIG. 3.

Referring to FIG. 3, in the method for generating a broadcast transmission signal based on signaling encoding using a polar code according to an embodiment of the present disclosure, the polar encoder of a broadcast transmission signal generation apparatus generates a polar codeword by encoding an input bit sequence based on a polar code at step S310.

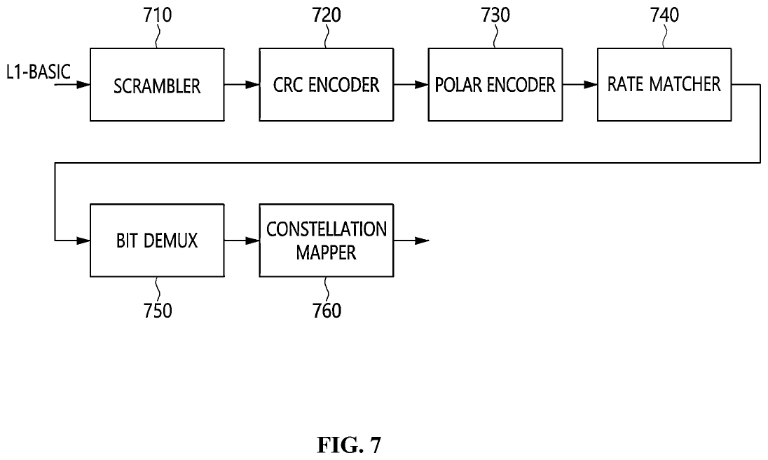

Below, the polar encoding process will be described in detail with reference to FIG. 6.

Referring to FIG. 6, the size of the mother matrix N of the polar code may be determined in conformity with N=2^{┌log}^{₂}^{E┐} or N=2^{┌log}^{₂}^{E┐-1} for the length E of a transmission bit sequence at step S610.

That is, the size of the mother matrix N may have a value in the form of a power of 2, and may be determined to be N=2^{┌log}^{₂}^{E┐} or N=2^{┌log}^{₂}^{E┐-1} when the length of the bit sequence is E after rate matching. When the maximum value of N is preset, it may be limited to a value less than or equal to the maximum value.

Here, when the size of the mother matrix is N=2^{┌log}^{₂}^{E┐}, a puncturing or shortening method may be used for rate matching, whereas when the size of the mother matrix is N=2^{┌log}^{₂}^{E┐-1}, a repetition method may be used for rate matching.

For example, N may always have a value fixed at 1024 or may be one value selected from 512 and 1024. In this case, a polar code sequence used in the control channel of 3GPP NR may be used as a polar code sequence.

Thereafter, the number of frozen bits may be determined in consideration of the number of signaling bit sequences K in L1-basic signaling subjected to outer encoding, or segmented L1-detail signaling at step S620.

Here, the number of frozen bits may correspond to a value N−(K+C) obtained by subtracting the sum of the number of signaling bit sequences K and the parity length C of an outer code, on which outer encoding is performed, from the input bit length N of the polar encoding graph corresponding to the mother matrix size N.

Thereafter, the position of the frozen bits may be determined in consideration of a predefined polar code sequence at step S630, and polar encoding may be performed at step S640.

Here, the frozen bits may be located at the front or rear of the predefined polar code sequence among the input bits of the polar encoding graph.

For example, when polar encoding is performed using a mother matrix of length N, the number of frozen bits among input vectors of length N, which is multiplied by the polar encoding graph, may be determined based on the number of L1-basic signaling bit sequences subjected to CRC outer encoding, or the number of segmented L1-detail signaling bit sequences.

Assuming that the number of L1-basic signaling bits or the number of segmented L1-detail signaling bits is K and a CRC code having a parity length of C is used as an outer code, the number of frozen bits may be determined to be N−(K+C).

Here, N−(K+C) frozen bit positions, among N input bit positions in the polar encoding graph, may be determined based on the predefined polar code sequence.

Here, frozen values may be input to consecutive N−(K+C) positions from the front or rear of the predefined polar code sequence, and outer-encoded signaling bit sequences may be sequentially input to the remaining K+C positions.

When a puncturing or shortening method is used during a rate matching operation, an outer-encoded signaling bit sequence may be input only to the remaining bit positions other than the positions to which frozen bits are forcibly allocated based on the polar code sequence.

For example, when the length of the polar code sequence is 1024 or 512, a polar code sequence used in the control channel of 3GPP NR may be utilized. Alternatively, a polar code sequence for an arbitrary length may be mathematically defined by calculating a polarization weight using bit positions and weights based on the index of a bit sequence. Alternatively, a polar code sequence having an arbitrary length greater than 1024 may be generated using an equation that calculates a polarization weight based on the polar code sequence of length 1024, which is used in the control channel of 3GPP NR.

Further, in the method for generating a broadcast transmission signal based on signaling encoding using a polar code according to the embodiment of the present disclosure, the rate matcher of the broadcast transmission signal generation apparatus selects a rate matching method in consideration of the mother matrix size N of the polar code and the length E of a transmission bit sequence at step S320.

Here, the rate matching method may be selected as any one of puncturing, shortening, and repetition.

For example, in order to generate a transmission bit sequence of length E from a polar codeword of length N, a puncturing, shortening or repetition method may be used.

Here, the rate matching method may be selected as any one of the puncturing or shortening method when the length of the transmission bit sequence E is less than the mother matrix size N, and may be selected as the repetition method when the length E of the transmission bit sequence is greater than the mother matrix size N.

For example, the size of a virtual circular buffer may be fixed either at 1024 or at 512 or 1024. Here, in the case of L1-detail signaling, when the length of the transmission bit sequence E is less than the length of a polar codeword N, either the puncturing or shortening methods may be used, or alternatively only the puncturing method may be used.

Here, whether to use the shortening method may be determined depending on whether additional parity for L1-detail signaling is to be transmitted. For example, when additional parity is to be transmitted, it is possible to use only the puncturing and repetition method without using the shortening method.

In this case, each of puncturing and shortening is a method for extracting some bits corresponding to E bits from bits forming a polar codeword of length N, wherein unselected (N−E) bits may be considered to be punctured or shortened.

For example, referring to FIG. 2, during a process of allocating input bits of a polar encoder to sub-channels, information bits may not be allocated to some sub-channels depending on the positions of punctured or shortened bits. In particular, when the shortening method is used, it may include an operation of mapping preset bit positions among the input bit positions of the polar encoder to frozen bits of ‘0’ so that preset bits in the output bit sequence x of the polar encoder have a value of ‘0’. Also, when the puncturing method is used, preset bits in the output bit sequence x of the polar encoder may be punctured and not transmitted. In this case, some bits among u bits may be selected based on the positions of the punctured bits, and then frozen bits may be mapped to the bits.

Furthermore, in the method for generating a broadcast transmission signal based on signaling encoding using a polar code according to the embodiment of the present disclosure, the rate matcher of the broadcast transmission signal generation apparatus generates the transmission bit sequence from the polar codeword using the selected rate matching method at step S330.

For example, the rate matcher of the broadcast transmission signal generation apparatus according to the present disclosure may output the bit sequence to be transmitted by receiving the output bit sequence of the polar encoder. Here, a bit sequence of length E may be generated from the output bit sequence x of the polar encoder through rate matching.

Here, rate matching may generate the transmission bit sequence by storing the polar codeword in the virtual circular buffer, and then sequentially extracting bits in the order of bits stored in the virtual circular buffer. Before the polar codeword is stored in the virtual circular buffer, interleaving may be performed, and the order of bits forming the codeword may be changed through interleaving. The interleaving operation may be applied to enhance the reception performance of polar-encoded L1 signaling, and, for example, subblock-type interleaving used in the control channel of 3GPP NR may be utilized.

For example, the rate matcher for the polar code for the control channel of 3GPP NR may generate x′ by interleaving the bit sequence x in units of 32 subblocks and rearranging the bits in the bit sequence. After the x′ generated in this way is stored in the virtual circular buffer, bits starting from a predefined bit position may be sequentially extracted by a length of E from the x′ in the virtual circular buffer, and thus the bit sequence to be used for the transmission signal may be generated.

Here, shortening may perform rate matching by extracting bits while leaving (N−E) bits from the end of the virtual circular buffer in which the polar codeword is stored.

Here, puncturing may perform rate matching by skipping (N−E) bits from the start of the virtual circular buffer in which the polar codeword is stored, and then extracting bits from the next position.

The repetition may perform rate matching by extracting all of N bits stored in the virtual circular buffer in which the polar codeword is stored, and then repeatedly extracting the remaining (E−N) bits from the start of the virtual circular buffer.

Furthermore, in the method for generating a broadcast transmission signal based on signaling encoding using a polar code according to the embodiment of the present disclosure, the additional parity generator of the broadcast transmission signal generation apparatus generates additional parity bits in consideration of the rate matching method at step S340.

For example, when additional parity is transmitted to enhance the reception performance of L1-detail signaling, the length of additional parity transmitted in a previous frame may be either half of or equal to the length of a bit sequence transmitted in the current frame.

Here, in order to generate the additional parity, a method using bits included in the virtual circular buffer used for rate matching and a method of generating a new bit sequence and transmitting it as additional parity may be employed. In the present disclosure, a method for generating additional parity from the bit sequence stored in the virtual circular buffer will be described.

A polar codeword generated through polar encoding may be stored in the virtual circular buffer, after which an output bit sequence may be generated by extracting bits from the virtual circular buffer through rate matching. In this case, depending on which one of puncturing, shortening, and repetition is to be used, a method for generating additional parity may vary.

When shortening is used as the rate matching method, the additional parity bits may be generated by storing the remaining bits, excluding shortened bits from the bits stored in the virtual circular buffer, in an additional virtual circular buffer, and then sequentially extracting bits from the additional virtual circular buffer.

For example, when the shortening method is used during rate matching, ‘O’ is forcibly allocated to the shortened bits among the bits of the polar codeword, and thus at the time of generating additional parity, the additional parity may be generated using only the remaining bits, excluding the shortened bits from the bits of the polar codeword.

Here, assuming that the remaining bits of the polar codeword, excluding the shortened bits, may be stored in the additional virtual circular buffer and that the length of the polar codeword is N and the number of shortened bits is p, the size of the additional virtual circular buffer may be (N−p). Assuming that the number of bits in the additional parity is ‘a’, an additional parity bit sequence may be generated by sequentially extracting ‘a’ bits from the start of the virtual circular buffer having a size of (N−p). When ‘a’ is greater than (N−p), an additional parity bit sequence having a desired length may be generated by repeatedly extracting bits from the virtual circular buffer.

In this case, when puncturing is used as the rate matching method, the additional parity bits may be generated by sequentially extracting bits starting from a punctured bit among the bits stored in the virtual circular buffer.

For example, when the puncturing method is used during rate matching, a bit sequence for additional parity may be generated by utilizing the virtual circular buffer having a size of N, which is used in rate matching, without change. Here, the bit sequence for additional parity may be generated by extracting bits immediately following a point at which bit extraction for output bit sequence generation during rate matching is terminated. This may mean that the bit sequence to be used for additional parity is generated by sequentially extracting bits starting from the punctured bit from the virtual circular buffer.

In this case, when repetition is used as the rate matching method, the additional parity bits may be generated by sequentially extracting bits following the last bit extracted through the repetition from the virtual circular buffer.

For example, when the repetition method is used during rate matching, a bit sequence for additional parity may be generated by utilizing the virtual circular buffer having a size of N without change, similarly to the puncturing method. Here, the bit sequence for additional parity may be generated by extracting bits immediately following a point at which bit extraction for output bit sequence generation during rate matching is terminated. This may mean that the bit sequence to be used for additional parity is generated by sequentially extracting bits, following a point at which bits extracted through the application of the repetition method are terminated, from the virtual circular buffer.

By means of the broadcast transmission signal generation method, the polar code may be used to encode signaling information and to generate and transmit a transmission signal.

Further, additional parity may be generated and transmitted to enhance the reception performance of signaling encoded using a polar code.

FIG. 4 is a diagram illustrating an example of a process for receiving L1-basic signaling and generating a transmission signal according to an embodiment of the present disclosure.

Referring to FIG. 4, a process of generate a broadcast transmission signal by encoding L1-basic signaling using a polar code according to the present disclosure is illustrated.

Here, L1-basic signaling may be a bit sequence of 200 bits, and the generation of a transmission signal may include various operations including a polar encoding process for protecting L1-basic signaling.

First, L1-basic signaling of length K may be scrambled using an arbitrary bit sequence at step S410. Here, the bit sequence used for scrambling may be generated from a 16-bit shift register structure, and a generator polynomial of the shift register may be established by the following Equation (3).

$$G ( X ) = 1 + X + {X}^{3} + {X}^{6} + {X}^{7} + {X}^{11} + {X}^{12} + {X}^{13} + {X}^{16} \qquad ( 3 )$$

Here, the initial sequence of the shift register may be set to 0xF180 (1111 0001 1000 0000).

The bit sequence subjected to scrambling (i.e., scrambled bit sequence) may be converted into a bit sequence of length K+C through outer encoding using a CRC code at step S420.

Here, the parity length C of the CRC code is 16 bits or more, and CRC parity bits of 16 bits or more may be masked with a Radio Network Temporary Identifier (RNTI). For example, as RNTI values, G-RNTI or G-CS-RNTI that is RNTI used for 3GPP multicast/broadcast transmission may be utilized. In this case, the parity length of the CRC code may be 16 bits, which is the same as the RNTI length, or may be 24 bits to enhance error detection capability of the CRC code.

The bit sequence of length K+C, subjected to outer encoding, may undergo inner encoding through a polar encoder having a mother matrix length (size) of N at step S430, where the mother matrix length N may have a value greater than K+C.

After polar encoding is performed, a polar codeword of length N may be generated, and a bit sequence of length E may be generated through rate matching at step S440.

In this case, when the length E of the bit sequence is less than the length N of the polar codeword, a puncturing or shortening method may be applied, and thus some bits of the polar codeword may not be included in the bit sequence. On the other hand, when the length E of the bit sequence is greater than the length N of the polar codeword, a repetition method may be applied, and thus a bit sequence of length E may be generated by repeatedly extracting, one or more times, all or some bits in the bit sequence of length N.

The bit sequence of length E, generated after rate matching, may be converted into a bit sequence of the same length E, in which the arrangement order of bits is changed, through interleaving at step S450. In this case, interleaving may be used to enhance reception performance when the bit sequence generated from the polar codeword is modulated through quadrature amplitude modulation (QAM) or non-uniform constellation (NUC) and then transmitted.

For example, an interleaver for performing interleaving may have the form of a triangular interleaver used in the uplink control information (UCI) transmission signal generation process of 3GPP NR.

The bit sequence subjected to interleaving is converted into QAM or NUC modulation symbols using QAM or NUC signal constellation at step S460, and the form and modulation order of the QAM or NUC signal constellation used here may be determined according to the mode applied to L1-basic signaling.

FIG. 5 is a diagram illustrating an example of a process for receiving L1-detail signaling and generating a transmission signal according to an embodiment of the present disclosure.

Referring to FIG. 5, a process of generating a broadcast transmission signal by encoding L1-detail signaling using a polar code according to the present disclosure is illustrated.

Hereinafter, descriptions of parts identical to the operations explained in FIG. 4 will be omitted, and only the operations different from those of the transmission signal generation method for L1-basic signaling transmission, as described in FIG. 4, will be explained.

The number of bits in L1-detail signaling is variable depending on the number of subframes forming a frame in which L1-detail signaling is transmitted and the number of PLPs, and may have a length ranging from a minimum of 200 bits to a maximum of several thousands of bits or more.

In this case, when the number of bits in L1-detail signaling is equal to or greater than a preset number, the L1-detail signaling is segmented into multiple segments at step S510, after which a process ranging from scrambling at step S520 to interleaving at steps S570 and S571 is performed on bit sequences for respective segments.

Thereafter, bit sequences corresponding to the multiple segments may be combined into a single bit sequence through concatenation at steps S580 and S581.

That is, scrambling at step S520, CRC outer encoding at step S530, polar encoding at step S540, and rate matching at step S550, performed on bit sequences for respective segments, may undergo the same process as the transmission signal generation operation for L1-basic signaling, described above with reference to FIG. 4.

However, unlike L1-basic signaling, in L1-detail signaling, additional parity may be generated and transmitted to enhance reception performance, and additional parity may be generated at step S560 after rate matching at step S550.

For example, additional parity for L1-detail signaling that is transmitted in an i-th frame may be transmitted in advance with it included in an (i−1)-th frame. By means of this, when L1-detail signaling is decoded in a reception stage, reception performance may be enhanced by utilizing time diversity corresponding to the frame length.

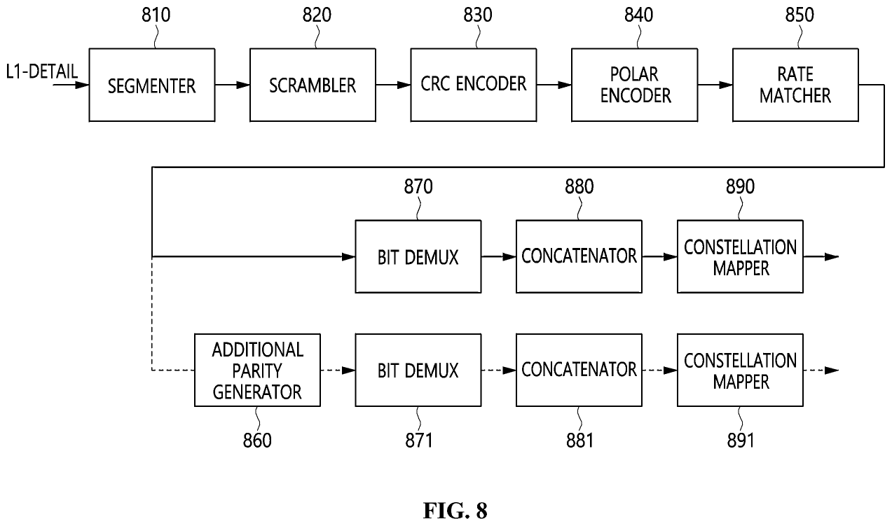

FIGS. 7 and 8 are diagrams illustrating an apparatus for generating a broadcast transmission signal based on signaling encoding using a polar code according to an embodiment of the present disclosure.

Referring to FIG. 7, the apparatus for generating a broadcast transmission signal based on signaling encoding using a polar code according to the embodiment of the present disclosure may include a scrambler 710, a CRC encoder 720, a polar encoder 730, a rate matcher 740, a bit demultiplexer (DEMUX) 750, and a constellation mapper 760.

Hereinafter, a process of performing L1-basic signaling will be described in detail based on the components of FIG. 7.

Here, L1-basic signaling may be a bit sequence of 200 bits, and the generation of a transmission signal may include various operations including a polar encoding process for protecting L1-basic signaling.

First, the scrambler 710 may scramble L1-basic signaling of length K using an arbitrary bit sequence. Here, the bit sequence used for scrambling may be generated from a 16-bit shift register structure, and a generator polynomial of the shift register may be established by the foregoing Equation (3).

Here, the initial sequence of the shift register may be set to 0xF180 (1111 0001 1000 0000).

Thereafter, the CRC encoder 720 may output a bit sequence of length K+C by performing outer encoding using a CRC code on the bit sequence subjected to scrambling (scrambled bit sequence).

Here, the parity length C of the CRC code is 16 bits or more, and CRC parity bits of 16 bits or more may be masked with a Radio Network Temporary Identifier (RNTI). For example, as RNTI values, G-RNTI or G-CS-RNTI that is RNTI used for 3GPP multicast/broadcast transmission may be utilized. In this case, the parity length of the CRC code may be 16 bits, which is the same as the RNTI length, or may be 24 bits to enhance error detection capability of the CRC code.

Thereafter, the polar encoder 730 may generate a polar codeword of length N by performing inner encoding on the bit sequence of length K+C based on a mother matrix of length N.

Here, the length N of the mother matrix may have a value greater than K+C.

Thereafter, the rate matcher 740 may generate a bit sequence of length E through rate matching.

In this case, when the length E of the bit sequence is less than the length N of the polar codeword, a puncturing or shortening method may be applied, and thus some bits of the polar codeword may not be included in the bit sequence. On the other hand, when the length E of the bit sequence is greater than the length N of the polar codeword, a repetition method may be applied, and thus a bit sequence of length E may be generated by repeatedly extracting, one or more times, all or some bits in the bit sequence of length N.

Thereafter, the bit DEMUX 750 may perform interleaving on the bit sequence of length E to convert the bit sequence into a bit sequence of the same length E in which the arrangement order of bits is changed.

In this case, interleaving may be used to enhance reception performance when the bit sequence generated from the polar codeword is modulated through quadrature amplitude modulation (QAM) or non-uniform constellation (NUC) and then transmitted.

For example, an interleaver for performing interleaving may have the form of a triangular interleaver used in the uplink control information (UCI) transmission signal generation process of 3GPP NR.

Thereafter, the constellation mapper 760 may convert the bit sequence subjected to interleaving into QAM or NUC modulation symbols using QAM or NUC signal constellation.

Here, the form and modulation order of the QAM or NUC signal constellation used here may be determined according to the mode applied to L1-basic signaling.

Also, referring to FIG. 8, the apparatus for generating a broadcast transmission signal based on signaling encoding using a polar code according to an embodiment of the present disclosure may further include a segmenter 810, an additional parity generator 860, and concatenators 880 and 881 in addition to the configuration illustrated in FIG. 7.

Hereinafter, a process of performing L1-detail signaling will be described in detail based on the components of FIG. 8.

In this case, in FIG. 8, descriptions of configurations identical to the operations explained in FIG. 7 will be omitted, and only the configurations different from those of the transmission signal generation apparatus for L1-basic signaling transmission, as described in FIG. 7, will be explained.

The number of bits in L1-detail signaling is variable depending on the number of subframes forming a frame in which L1-detail signaling is transmitted and the number of PLPs, and may have a length ranging from a minimum of 200 bits to a maximum of several thousands of bits or more.

The segmenter 810 may segment bits in L1-detail signaling into multiple segments when the number of bits in L1-detail signaling is equal to or greater than a preset number.

Thereafter, each of the concatenators 880 and 881 may combine bit sequences corresponding to the multiple segments into a single bit sequence.

Here, the processing performed by the scrambler 820, the CRC encoder 830, the polar encoder 840, and the rate matcher 850 for bit sequences corresponding to respective segments may undergo the same process as the operation of generating the transmission signal for L1-basic signaling, described above with reference to FIG. 7.

However, unlike L1-basic signaling, in L1-detail signaling, additional parity may be generated and transmitted by the additional parity generator 860 to enhance reception performance, and additional parity may be generated after processing by the rate matcher 850.

For example, additional parity for L1-detail signaling that is transmitted in an i-th frame may be transmitted in advance with it included in an (i−1)-th frame. By means of this, when L1-detail signaling is decoded in a reception stage, reception performance may be enhanced by utilizing time diversity corresponding to the frame length.

In this case, the detailed operation methods of the polar encoder 730 or 840, the rate matcher 740 or 850, and the additional parity generator 860, illustrated in FIG. 7 or 8, have been sufficiently described above with reference to FIG. 3, and thus detailed description thereof will be omitted.

Further, the embodiment of the present disclosure may be implemented as a non-transitory computer-readable medium in which a computer-implemented method or computer-executable instructions are stored. When the computer-readable instructions are executed by a processor, the computer-readable instructions may perform the method according to at least one aspect of the present disclosure.

By means of the broadcast transmission signal generation apparatus, the polar code may be used to encode signaling information and to generate and transmit a transmission signal.

Further, additional parity may be generated and transmitted to enhance the reception performance of signaling encoded using a polar code.

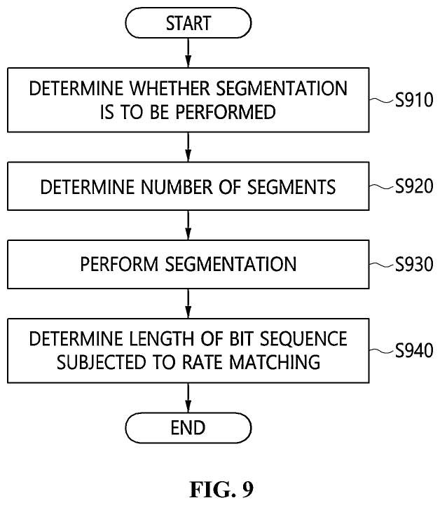

FIG. 9 is an operation flowchart illustrating a method for generating a broadcast transmission signal using signaling segmentation based on polar encoding according to an embodiment of the present disclosure.

Here, the physical layer signals of ATSC 3.0 are transmitted in frames, and each frame is composed of a bootstrap, a preamble, and a subframe. In order to receive data that is transmitted through the subframe, L1-basic signaling and L1-detail signaling which are transmitted through the preamble need to be successfully decoded in a reception stage. For this operation, the present disclosure may use a CRC code as an outer code and use a polar code as an inner code to generate a broadcast transmission signal.

Here, in the process of generating the broadcast transmission signal, the remaining process other than segmentation and rate matching has been described in detail with reference to FIG. 5, and thus detailed description thereof is omitted. Details of a segmentation and rate matching process for L1-detail signaling in the broadcast transmission signal generation process will be described with reference to FIG. 9.

Referring to FIG. 9, in the method for generating a broadcast transmission signal using signaling segmentation based on polar encoding according to an embodiment of the present disclosure, the segmenter of the broadcast transmission signal generation apparatus determines whether segmentation for L1-detail signaling is to be performed by applying at least one of multiple conditions that are set based on the mother matrix size N of a polar code, the number of bits K in L1-detail signaling, and the length E of a transmission bit sequence, or a combination thereof, at step S910.

Here, the multiple conditions may include a first condition in which segmentation is performed when K≥(N−C) is satisfied based on the number of parity bits C in the CRC code, a second condition in which segmentation is performed when E≥B is satisfied based on a first parameter B that is set in consideration of N, and a third condition in which segmentation is performed when E≥B is satisfied while K≥A is satisfied based on a second parameter A that is set in consideration of N.

That is, it may be assumed that the number of bits in L1-detail signaling is K and the length of bit sequences to be included in a transmission signal for L1-detail signaling is E. In this case, it may be assumed that L1-detail signaling is encoded by utilizing a concatenated code in which a CRC code in which the number of parity bits is C is used as an outer code and a polar code is used as an inner code using the mother matrix of length N.

Further, in the method for generating a broadcast transmission signal using signaling segmentation based on polar encoding according to the embodiment of the present disclosure, the segmenter of the broadcast transmission signal generation apparatus determines the number of segments based on parameters that are set in consideration of N when performing segmentation at step S920.

Here, the number of segments C may be determined to be c=┌K/(N−C−1)┐ when segmentation is performed by satisfying the first condition, to be c=┌E/(B−1)┐ when segmentation is performed by satisfying the second condition, and to be c=min (┌K/(A−1)┐, ┌E/(B−1)┐) when segmentation is performed by satisfying the third condition.

Furthermore, in the method for generating a broadcast transmission signal using signaling segmentation based on polar encoding according to the embodiment of the present disclosure, the segmenter of the broadcast transmission signal generation apparatus performs segmentation in accordance with the determined number of segments at step S930.

Hereinafter, when L1-detail signaling is encoded using a concatenated code in which a polar code is used as an inner code according to the present disclosure, a process of performing segmentation based on the first condition, the second condition, and the third condition will be described in detail.

### (First Condition)

The first condition may be set based on the fact that the length of bit sequences K+C input to a polar encoding graph should be less than the size of the mother matrix N used for polar encoding. That is, based on K+C<N, it may be determined that segmentation needs to be performed for the case of K≥(N−C) that does not satisfy K+C<N.

In an example, assuming that N is 1024 and C is 16, segmentation may be performed when K≥1008 is satisfied. In another example, assuming that N is 1024 and C is 24, segmentation may be performed when K≥1000 is satisfied.

In this way, when segmentation is performed based on the first condition, the number of segments c may be determined to be c=┌K/(N−C−1)┐.

### (Second Condition)

A repetition operation, performed when the length of bit sequences E to be included in the transmission signal is greater than the size of the mother matrix N, cannot have a coding gain through polar encoding. In this case, there is a need to prevent the magnitude of E from increasing above a certain degree from N. Therefore, the second condition may be applied, whereby segmentation needs to be performed when E≥B, where parameter B may be determined according to N.

For example, when N is 1024, E may be set to 1088.

In this way, when segmentation is performed based on the second condition, the number of segments c may be determined to be c=┌E/(B−1)┐.

For example, when N is 1024, c may be set to c=┌E/1087┐.

### (Third Condition)

A coding gain that can be achieved through polar encoding may be determined according to the code rate of the polar code, and the code rate of the polar code may correspond to (K+C)/N.

Here, in order to secure the coding gain through polar encoding, segmentation needs to be performed when the length of an input bit sequence is equal to or greater than a certain size so as to prevent the code rate of the polar code from excessively increasing. Furthermore, a repetition operation, performed when the length of bit sequences E to be included in the transmission signal is greater than the size of the mother matrix N, cannot have a coding gain through polar encoding, and thus there is a need to prevent the magnitude of E from increasing above a certain degree from N.

When the third condition including such two criteria is satisfied, segmentation needs to be performed. That is, when K≥A and E≥B are simultaneously satisfied, segmentation needs to be performed, where parameter A may be determined according to N.

For example, when N is 1024, A may be set to 360, and E may be set to 1088.

In this way, when segmentation is performed based on the third condition, the number of segments c may be determined to be c=min (┌K/(A−1)┐, ┌E/(B−1)┐).

For example, when N is 1024, c may be set to c=min (┌K/359┐, ┌E/1087┐). Here, min (I,J) may refer to the smaller value between I and J.

Here, because the first condition, the second condition, and the third condition may not have an inclusion relationship with one another, the actual segmentation may be performed in consideration of one or more of the first, second and third conditions described above.

In an example, segmentation may be performed in consideration of only the third condition.

In another example, when the first condition and the third condition are simultaneously taken into consideration, segmentation may be performed when one or more of the two conditions are satisfied. Here, the number of segments c may be determined to be the larger value among the numbers of segments derived according to respective conditions.

Furthermore, in the method for generating a broadcast transmission signal using signaling segmentation based on polar encoding according to the embodiment of the present disclosure, the rate matcher of the broadcast transmission signal generation apparatus determines the length of the bit sequence subjected to rate matching in consideration of a target block error rate and the number of bits in the segmented L1-detail signaling at step S940.

In this case, in consideration of a situation in which, as the length of the bit sequences ‘e’ subjected to rate matching increases, the block error rate decreases, the ‘e’ for the number of bits k in the segmented L1-detail signaling may be determined based on the target block error rate.

For example, when an arbitrary input bit sequence is transmitted after being polar encoded, reception performance in a reception stage may be enhanced as the length of the output bit sequence subjected to rate matching increases. Therefore, for various k values based on the performance at the target block error rate, the length of the output bit sequence ‘e’ may be determined.

Here, the length of the output bit sequence ‘e’ for each k value may be determined such that reception performance remains as consistent as possible at various input bit sequence lengths k.

In an example, when the effective code rate of a concatenated code including even rate matching is k/e and the target block error rate is as low as 10⁻⁴ to 10⁻⁷, ‘e’ may be determined in such a way that, as k is smaller, the effective code rate k/e becomes smaller. This reflects a tendency that, if polar encoding having the same code rate is undergone when the target block error rate is low, reception performance is deteriorated as k becomes smaller.

In another example, for arbitrary k, ‘e’ may be predetermined and used based on an equation defined in ATSC 3.0. This means that, when L1 signaling is protected through LDPC encoding in ATSC 3.0, the number of parity bits in a polar code is determined using a procedure for determining the number of parity bits in the LDPC code. This case may mean that, for arbitrary k, the number of parity bits in the LDPC code, derived in consideration of repetition and puncturing operations defined in ATSC 3.0, and the number of parity bits (e−k) in the polar code are set to the same value. In this case, for arbitrary k, the number of parity bits (e−k) in the polar code may be set to the number of parity bits in the LDPC code in ATSC 3.0, or may be set to the sum of the number of parity bits in the LDPC code and the number of parity bits in a BCH code.

In a further example, the length of the output bit sequence ‘e’ may be defined in the form of e=└A*k┘+B or e=┌A*k┐+B. In this case, A and B may be determined to be different values for respective modes applied to signaling, wherein A may have a fractional form and B may have an integer form. Further, for an arbitrary mode, as k is smaller, the effective code rate k/e may be set smaller, which may be intended to align the reception performance corresponding to the target block error rates for various k values as consistent as possible.

Here, ‘e’ may be a value in which p that is the number of punctured or shortened bits in rate matching and r that is the number of bits added through repetition in rate matching are applied to k.

That is, during rate matching for arbitrary k, ‘e’ may be defined by distinguishing the number of punctured or shortened bits p in the polar codeword from the number of bits r additionally selected through repetition. Here, when the mother matrix size of the polar code is N, ‘e’ may be defined as e=(N−p)+r.

For example, when an arbitrary input bit sequence is polar-encoded and then transmitted, reception performance in a reception stage may be deteriorated as the number of punctured or shortened bits p increases while rate matching is performed. That is, when only puncturing or shortening is applied to the polar codeword without a repetition operation, the effective code rate of a concatenated code may be k/(N−p).

Therefore, based on performance at the target block error rate, the numbers of bits p to be punctured or shortened for various k values may be determined.

Here, the numbers of bits p to be punctured or shortened for various k values may be determined such that the reception performance remains as consistent as possible at various input bit sequence lengths k.

For example, the number to be punctured or shortened bits p may be defined in the form of p=└A*(N−k)┘+B or p=┌A*(N−k)┐+B. Here, A and B may be determined to be different values for respective modes applied to signaling, where A may have a fractional form, and B may have an integer form. Further, ‘p’ may be set such that, as k is smaller for an arbitrary mode, the effective code rate becomes lower. This is intended to align the reception performance corresponding to the target block error rates for various k values as consistent as possible.

Furthermore, when an arbitrary input bit sequence is polar-encoded and then transmitted, reception performance in a reception stage may be enhanced as the number of bits additionally selected through the repetition method becomes larger while rate matching is performed. That is, when only the repetition method is applied to the polar codeword, the effective code rate of the concatenated code may be k/(N+r).

Therefore, based on performance at the target block error rate, the numbers of bits r to be additionally selected may be determined through the repetition method for various k values.

Here, r for each k value may be determined such that the reception performance remains as consistent as possible at various input bit sequence lengths k.

For example, r that is the number of bits to be additionally selected through the repetition method may be defined in the form of r=└I*k┘+J or r=┌I*k┐+J. In this case, I and J may be determined to be different values for respective modes that are applied to signaling, where I may be a fractional form and J may have an integer form. Furthermore, for an arbitrary mode, r may be set such that, as k is smaller, the effective code rate becomes lower. This is intended to align the reception performance at the target block error rates for various k values as consistent as possible.

Further, although not illustrated in FIG. 3, in the method for generating a broadcast transmission signal using signaling segmentation based on polar encoding according to an embodiment of the present disclosure, the rate matcher of the broadcast transmission signal generation apparatus may determine the rate matching method by comparing N with ‘e’ when ‘e’ is determined.

In this case, when e>N is satisfied, repetition may be used, whereas when e<N is satisfied, puncturing or shortening may be used.

That is, when ‘e’ is determined based on the equation, ‘e’ is compared with the mother matrix size N of the polar code. When ‘e’ is greater than N, the repetition method is used, whereas when ‘e’ is less than N, the puncturing or shortening method is used, and thus a transmission bit sequence subjected to rate matching may be generated from the polar codeword. In this case, the repetition method may not be used simultaneously with the use of the puncturing or shortening method.

By means of the broadcast transmission signal generation method, segmentation of signaling information bits may be performed and a rate matching operation may be performed, during a process of encoding signaling information and generating a transmission signal by using a polar code.

According to the present disclosure, signaling information may be encoded and transmission signals may be generated and transmitted by using a polar code.

Further, the present disclosure may generate and transmit additional parity to enhance the reception performance of signaling encoded using a polar code.

Furthermore, the present disclosure may perform segmentation on signaling information bits and a rate matching operation during a process of encoding signaling information and generating a transmission signal using a polar code.

As described above, in the method for generating a broadcast transmission signal based on signaling encoding using a polar code and the apparatus for the method according to the present disclosure, the configurations and schemes in the above-described embodiments are not limitedly applied, and some or all of the above embodiments can be selectively combined and configured so that various modifications are possible.

What is claimed is:

1. An apparatus for generating a broadcast transmission signal, comprising:
a polar encoder configured to generate a polar codeword by encoding an input bit sequence based on a polar code;
a rate matcher configured to select a rate matching method in consideration of a mother matrix size (N) of the polar code and a length of a transmission bit sequence (E), and generate the transmission bit sequence from the polar codeword using the selected rate matching method; and
an additional parity generator configured to generate additional parity bits in consideration of the rate matching method.

2. The apparatus of claim 1, wherein the rate matching method is selected as any one of puncturing, shortening, and repetition.

3. The apparatus of claim 2, wherein the rate matching method is selected as any one of the puncturing or the shortening when the length of the transmission bit sequence (E) is less than the mother matrix size (N), and is selected as the repetition when the length of the transmission bit sequence (E) is greater than the mother matrix size (N).

4. The apparatus of claim 3, wherein:
the shortening performs rate matching by extracting bits while leaving (N−E) bits from an end of a virtual circular buffer in which the polar codeword is stored,
the puncturing performs rate matching by skipping (N−E) bits from a start of the virtual circular buffer in which the polar codeword is stored, and then extracting bits from a next position, and
the repetition performs rate matching by extracting all of N bits stored in the virtual circular buffer in which the polar codeword is stored, and then repeatedly extracting remaining (E−N) bits from the start of the virtual circular buffer.

5. The apparatus of claim 4, wherein the polar codeword is subjected to interleaving, and then stored in the virtual circular buffer.

6. The apparatus of claim 4, wherein the additional parity generator is configured to, when the shortening is used as the rate matching method, generate the additional parity bits by storing remaining bits, excluding shortened bits from bits stored in the virtual circular buffer, in an additional virtual circular buffer, and thereafter sequentially extracting bits from the additional virtual circular buffer.

7. The apparatus of claim 4, wherein the additional parity generator is configured to, when the puncturing is used as the rate matching method, generate the additional parity bits by sequentially extracting bits starting from a punctured bit among bits stored in the virtual circular buffer.

8. The apparatus of claim 4, wherein the additional parity generator is configured to, when the repetition is used as the rate matching method, generate the additional parity bits by sequentially extracting bits following a last bit extracted through the repetition from the virtual circular buffer.

9. The apparatus of claim 1, wherein the mother matrix size (N) is determined to correspond to N=2^{┌log}^{₂}^{E┐} or N=2^{┌log}^{₂}^{E┐-1} for the length (E) of the transmission bit sequence.

10. The apparatus of claim 9, wherein the polar encoder determines a number of frozen bits in consideration of a number of signaling bit sequences (K) in L1-basic signaling subjected to outer encoding or in segmented L1-detail signaling.

11. The apparatus of claim 10, wherein the number of frozen bits corresponds to a value N−(K+C) obtained by subtracting a sum of the number of signaling bit sequences (K) and a parity length (C) of an outer code, on which outer encoding is performed, from an input bit length (N) of a polar encoding graph corresponding to the mother matrix size (N).

12. The apparatus of claim 11, wherein the frozen bits are located at a front or rear of a predefined polar code sequence among input bits of the polar encoding graph.

13. A method for generating a broadcast transmission signal, the method being performed by an apparatus for generating a broadcast transmission signal, the method comprising:
generating a polar codeword by encoding an input bit sequence based on a polar code;
selecting a rate matching method in consideration of a mother matrix size (N) of the polar code and a length of a transmission bit sequence (E);
generating the transmission bit sequence from the polar codeword using the selected rate matching method; and
generating additional parity bits in consideration of the rate matching method.

14. A method for generating a broadcast transmission signal, the method being performed by an apparatus for generating a broadcast transmission signal, the method comprising:
determining whether segmentation is to be performed on L1-detail signaling by applying at least one of multiple conditions that are set based on a mother matrix size (N) of a polar code, a number of bits (K) in the L1-detail signaling, and a length of a transmission bit sequence (E), or a combination thereof;
when the segmentation is to be performed, determining a number of segments based on parameters that are set in consideration of N; and
performing segmentation in accordance with the determined number of segments, and determining a length of a bit sequence subjected to rate matching in consideration of a target block error rate and a number of bits in segmented L1-detail signaling.

15. The method of claim 14, wherein the multiple conditions include a first condition in which the segmentation is performed when K≥(N−C) is satisfied based on a number of parity bits (C) in a CRC code, a second condition in which the segmentation is performed when E≥B is satisfied based on a first parameter (B) that is set in consideration of N, and a third condition in which the segmentation is performed when E≥B is satisfied while K≥A is satisfied based on a second parameter (A) that is set in consideration of N.

16. The method of claim 15, wherein the number of segments (c) is determined to be c=┌K/(N−C−1)┐ when the segmentation is performed by satisfying the first condition, to be c=┌E/(B−1)┐ when the segmentation is performed by satisfying the second condition, and to be c=min (┌K/(A−1)┐, ┌E/(B−1)┐) when the segmentation is performed by satisfying the third condition.

17. The method of claim 14, wherein determining the length of the bit sequence subjected to the rate matching comprises: in consideration of a situation in which, as (e) that is the length of the bit sequence subjected to the rate matching increases, the block error rate decreases, determining the length of the bit sequence (e) for the number of bits (k) in the segmented L1-detail signaling based on the target block error rate.

18. The method of claim 17, wherein the length of the bit sequence (e) is a value in which a number of bits (p) punctured or shortened in rate matching and a number of bits (r) added through repetition in rate matching are applied to the k.

19. The method of claim 18, further comprising:
when the (e) is determined, determining the rate matching method by comparing, by the broadcast transmission signal generation apparatus, the mother matrix size (N) of the polar code with the length of the bit sequence (e) subjected to the rate matching.

20. The method of claim 19, wherein determining the rate matching method comprises:
using repetition when e>N is satisfied, and using puncturing or shortening when e<N is satisfied.
